(19) United States
(12) Patent Application Publication
(10) Pub. No.: US 2011/0298203 A1
(43) Pub. Date: Dec. 8, 2011

(54) DOCUMENT AUTHENTICATION ENHANCEMENT PROCESSES

(75) Inventors: David H. Pan, Rochester, NY (US); Pinyen Lin, Rochester, NY (US); Zhigang Fan, Webster, NY (US)

(73) Assignee: XEROX CORPORATION, Norwalk, CT (US)

(21) Appl. No.: 12/791,916

(22) Filed: Jun. 2, 2010

(51) Int. Cl. B42D 15/00

(52) U.S. Cl. 283/67; 283/73

(57) ABSTRACT

Disclosed are anti-counterfeiting methods which use a fiduciary marker encoded with the location of a hidden security feature. Documents produced by the methods, and methods for verifying authenticity of documents produced by the methods, are also disclosed.

### BACKGROUND

The present disclosure relates to anti-counterfeiting methods, authenticity verification methods, and counterfeit-proof documents. The methods improve document security by enhancing the efficiency of forensic examination in locating various security marks.

A great number of printed documents require highly reliable means of ensuring their authenticity. These documents include currency, negotiable instruments, stock certificates, checks, tickets, and the like. In the case of banknotes, passports, checks, and other intrinsically valuable documents, confidence in the authenticity of the document is especially important, as any member of the public might become a holder or user of the document at any time.

The criteria for an effective document security feature are relatively easy to formulate. The security feature should be permanent and durable. Such security features should also be difficult to replicate, to deter potential counterfeiters. In addition, the security feature should permit ready detection by means available to ordinary holders or users of the final document. For banknotes and other documents on whose authenticity the public at large relies, the security features should be discernible and verifiable under ordinary light conditions.

The increasing popularity of color photocopiers and other imaging systems, and the improving technical quality of color photocopiers, has led to an increase in the counterfeiting of such documentation.

A wide variety of security features for documents have been proposed previously. Examples of such security features include: optically variable devices, such as holograms and diffraction gratings; security threads or strips; microprint; watermarks; fine line or ‘filigree’ patterns; and color shifting inks, fluorescent inks, or phosphorescent inks.

There are three general categories of security marks or anti-counterfeiting features: Type I (overt), Type II (covert), and Type III (forensic). All three categories require the formation of an image on an item to be protected.

Type I features are obviously present, i.e. they are usually visible to the naked human eye without additional enhancement or equipment. However, Type I features are difficult to obtain or reproduce. Type I features are often integrated into packaging designs and marketing strategies.

Type II features are hidden technologies, i.e. not visible to the naked human eye without additional enhancement or equipment. Type II features are typically verified using easily portable handheld field devices, such as ultraviolet (UV) light. With field equipment, Type II features can be seen without difficulty.

Type III features are also hidden technologies. However, Type III features generally cannot be examined and verified using field equipment. Instead, examination with specialized equipment is required. Typically, the examination takes place in a laboratory. Counterfeiters often do not even know Type III features exist, or cannot find them even if Type III features are known to exist somewhere on an item.

Valuable prints often include multiple levels of security. For example, the United States ten dollar bill includes at least five security features: serial numbers, a water mark, a security thread, microprint, and a color shift ink. The presence of these security features reduces the overall amount of counterfeiting, makes counterfeiting more difficult, and generally increases the degree of confidence that counterfeit bills can be detected.

Even with specialized equipment, Type III features may be difficult to detect by examiners who are trying to authenticate a document, due to their small size and other factors. This problem is exacerbated when the document being analyzed is large and/or the person performing the examination does not know where the Type III security feature is hidden in the item. Type I and Type II features are easier to examine, but are also easier for counterfeiters to detect and thus for counterfeiters to attempt to copy.

It would be desirable to develop security methods that improve overall document security and also enhance the efficiency of forensic examination.

### BRIEF DESCRIPTION

The present application discloses, in various embodiments, anti-counterfeiting methods using a fiduciary marker on a document. The fiduciary marker contains encoded information about the location of other hidden security features on the document, allowing an examiner to locate those hidden security features and verify the authenticity of the document.

Disclosed herein are methods for reducing the difficulty of locating a hidden security feature on a substrate by a trusted party, comprising: printing the hidden security feature on the substrate; and printing a fiduciary marker on the substrate, the fiduciary marker encoding information about the location of the hidden security feature.

The fiduciary marker can be printed with a transparent ink. Alternatively, the fiduciary marker is visible.

The hidden security feature can be a micro-taggant, nanotext, an invisible barcode, an invisible image, a digital watermark, a hidden lenticular image, or a hidden polarized image.

The fiduciary marker can be printed on a blank space of the substrate. Alternatively, the fiduciary marker can be printed in yellow ink on a white background of the substrate.

The encoded information may also include the type of hidden security feature, and/or the equipment or methods needed to detect the hidden security feature.

Also disclosed are methods of verifying the authenticity of a document, comprising: locating a fiduciary marker on the document, the fiduciary marker encoding information, wherein the encoded information is supposed to disclose the location of a hidden security mark on the document; and decoding the information encoded in the fiduciary marker to determine whether the encoded information actually provides location information.

The method may further comprise examining the location retrieved from the fiduciary marker to determine whether the hidden security mark is present on the document.

Also disclosed is a document with enhanced security, comprising: a hidden security feature; and a fiduciary marker encoded with information about the location of the hidden security feature.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 illustrates the appearance of an exemplary counterfeit-proof document of the present disclosure to the human eye without enhancement.

FIG. 2 illustrates section 130 of the document of FIG. 1 during analysis with specialized equipment in a laboratory.

FIG. 3 is a flow chart of an exemplary process for creating a counterfeit-proof document.

FIG. 4 is a flow chart of an exemplary process for verifying the authenticity of a questionable document.

### DETAILED DESCRIPTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of “from about 2 to about 10” also discloses the range “from 2 to 10.”

The terms “overt” or “to the naked human eye” refers to marks which can be seen under normal lighting conditions by a person who has 20/20 vision, either naturally or with normal corrective means such as glasses or contact lenses.

The term “covert” refers to marks which cannot be seen under normal lighting conditions by a person with 20/20 vision, but which may be visible with the aid of additional equipment.

The present disclosure relates to documents that are more difficult to counterfeit, have enhanced security, and/or allow for enhanced verification of authenticity or forgery. Generally, such documents include at least one hidden security feature and a fiduciary marker. The fiduciary marker is encoded with information about the location of the hidden security feature(s). The fiduciary marker is decoded using a separate decryption key, i.e. a key that is separate from, and not physically on, the document whose authenticity is being verified. The presence or absence of the hidden security feature(s) at the given location(s) provides evidence of authenticity or forgery.

The present disclosure also relates to methods for reducing the difficulty of locating a hidden security feature on a substrate, or of increasing the difficulty of counterfeiting such a document, or of verifying the authenticity of a document. The methods include printing a hidden security feature on a substrate and printing a fiduciary marker on the substrate. The fiduciary marker is encoded with information about the location of the hidden security feature.

Also disclosed is a method of verifying the authenticity of a document. The method comprises locating a fiduciary marker on the document and decoding information encoded in the fiduciary marker to determine whether the fiduciary marker describes the location of a hidden security feature. The lack of the location information can be a signal that the fiduciary marker has been copied or forged, or the absence of the hidden security feature at the decoded location can be a signal that the document has been forged.

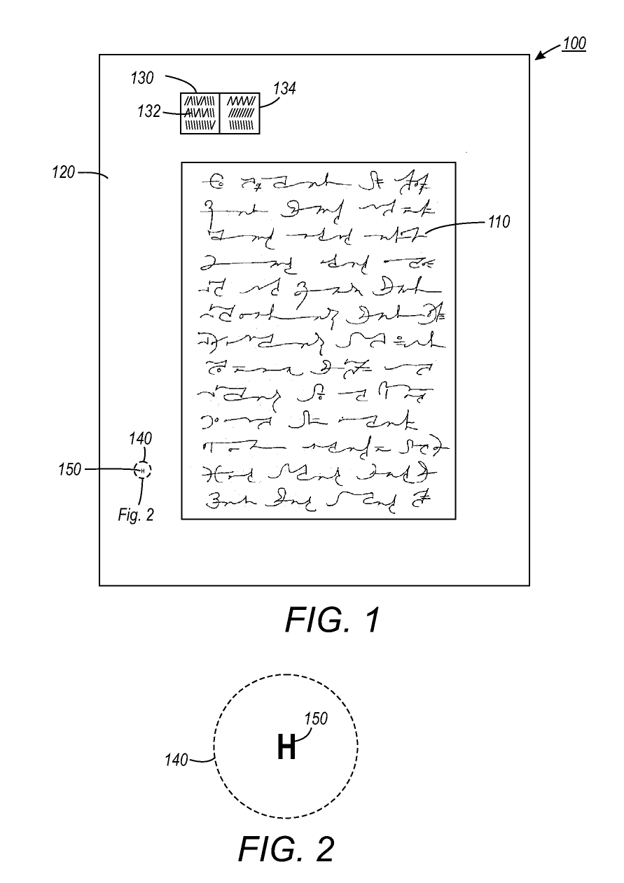

FIG. 1 shows an exemplary substrate 100 as it appears to the naked human eye. The substrate can be substantially any media or surface to which a security mark can be applied, such as paper, velum, acetate, etc. The substrate 100 includes a primary imaged area 110, where information is applied that constitutes the visible content of the document. For example, the primary imaged area on a page of a book would be the area where the text and/or illustrations is printed. The substrate 100 also includes a primary non-imaged area 120, or “blank space”. The non-imaged area is the space that is designated to be substantially empty of applied information. For example, the non-imaged area on a page of a book is typically the margin on the four sides of the page (top, bottom, left and right sides).

A fiduciary marker 130 is located on the substrate 100. As shown here, the fiduciary marker 130 is located in the blank space 120. However, the fiduciary marker 110 may be located in the primary imaged area instead of the margin. It is contemplated that across several different documents, the fiduciary marker should generally be in the same location on each document. This reduces the difficulties inherent in authenticating the document.

The fiduciary marker 130 may be an overt or covert security mark. In this regard, it can be desirable for the fiduciary marker on a document to be copied by a counterfeiter, as the fiduciary marker encodes information about the hidden security feature that exposes the copied document as either a copy (i.e. not the original) or as not being authentic. In some embodiments, the fiduciary marker is printed with a transparent or semi-transparent ink. In other embodiments, the fiduciary marker is printed in a yellow or other light-colored ink on a white background of the substrate.

The fiduciary marker is encoded with information about the location 140 of at least one hidden security feature 150. The hidden security feature itself is either covert or forensic, and is desirably forensic.

In this regard, the fiduciary marker 130 can take any form which may carry information. For example, the fiduciary marker can be a one-dimensional or two-dimensional bar code. Alternatively, the fiduciary marker can be a glyph, i.e. an image that imparts information, such as an arrow. Generally, any mark that can may be used to encode information about the location or locations of hidden security features on the substrate.

Generally, the fiduciary marker is a mark pattern which encodes information that can be detected, extracted, and decoded. The mark pattern is built up from smaller marks. Such marks can be dots, as is typically considered when xerographic printing is considered, but can be any other suitable shape, such as a square, triangle, irregular shape, or the like which is capable of detection. In some embodiments, the individual marks of the mark pattern may be too small to be visually apparent to the naked human eye. For example, each pixel in a 300 dots per inch (dpi) printing system has an average diameter of about 85 micrometers. In general, a pixel is the smallest mark which can be individually printed. An individual pixel is very difficult for the naked human eye to see.

All of the marks in the mark pattern may have the same size and/or shape. Each mark should be spaced from its nearest neighbor such that it can be distinguished therefrom when detected. Depending on the accuracy of the detection system, the marks may be spaced from their nearest neighbors by at least one pixel width, 3 pixels, or at least 5 pixels. In this way, the approximate locations of each mark, rather than specific locations, can be used to determine the mark pattern of the fiduciary marker. This allows compensation for a slight misregistration of the individual marks in the mark pattern when the fiduciary marker is being detected and decoded during authentication of the document.

The size and shape of the fiduciary marker is not particularly important, so long as the fiduciary marker is able to encode all of the needed information regarding the location(s) of the hidden security feature(s). In particular embodiments, the fiduciary marker is composed of a plurality of blocks, each block containing the information about the location of one hidden security feature. The blocks may be rectangular or may assume other shapes such as regular polygons. In some embodiments, the blocks are triangles, hexagons, trapezoids, or the like, which can fit together to form an array of blocks, which may be arranged in rows and columns in two directions, to make up the fiduciary marker. As depicted in FIG. 1, the fiduciary marker 130 is made up of two blocks 132, 134. Here, each block is depicted as a two-dimensional bar code.

The fiduciary marker contains encoded information about the location of the hidden security feature. Again, the decryption key for decoding the fiduciary marker should be physically separate from the document whose authentication is being verified. For example, if the fiduciary marker is a bar code, the location information should not be encoded only using the Universal Product Code (UPC) standard, as that standard would be available to counterfeiters as well, and not just to the trusted party who is trying to verify the authenticity of the document.

The hidden security feature 150 is not visible to the naked human eye. In particular embodiments, the hidden security feature is a Type III mark, i.e. a forensic mark. The hidden security feature can be a micro-taggant, nanotext, an invisible barcode, an invisible image, a digital watermark, a hidden lenticular image, or a hidden polarized image. A micro-taggant is a particle having a size in the range of 1 to 1000 micrometers, that has spectroscopic, magnetic, optical and/or electrical properties which are different from the substrate itself and which are detectable with forensic equipment. Nanotext is text that is printed at very small sizes, in the range of about 100 nm to about 900 nm; the text is difficult to read without forensic equipment. An invisible barcode or invisible image is printed using very fine lines, such as yellow lines on a white background. A digital watermark is a collection of minute changes in the printed image that is not perceivable by the naked eye, but is detectable by special computer algorithms. A lenticular image is an image that has an illusion of depth, or the ability to change or move as the image is viewed from different angles. A polarized image is an image that appears when a pair of different polarizing filters is used to restrict the light reaching each eye, so that each eye views only a part of the image but together the entire image is seen.

In particular embodiments, the hidden security feature is a fractal security mark. A fractal security mark is an irregular geometric object having an infinite nesting of structure at all scales.

FIG. 2 is a magnified view of the location 140 encoded in the fiduciary marker 120 of FIG. 1. Here, the hidden security feature 150 is shown.

As described here, the document includes a fiduciary marker that encodes the location of one or more hidden security features. The document may also include multiple fiduciary markers. Each of the fiduciary markers would be encoded with the locations of one, two, three, four, or more hidden security features.

The fiduciary marker and the hidden security feature(s) may generally be printed via digital printing, xerographic printing, ink jet printing, or any other type of printing.

It is contemplated that various computing environments would be used to detect the fiduciary marker, decode the location information in the fiduciary marker, and examine those location(s) for the hidden security feature(s). Those skilled in the art will appreciate that computer-executable instructions, such as program modules, can be executed by a single computer to perform these tasks. Generally, program modules include routines, programs, objects, components, data structures, etc., that perform particular tasks or implement particular abstract data types. Moreover, those skilled in the art will appreciate that the computer hardware can take many different forms, including hand-held devices, multi-processor systems, microprocessor-based or programmable consumer electronics, networked PCs, microcomputers, mainframe computers, and the like.

The detection module can employ one or more algorithms to extract information contained within the fiduciary marker. Algorithms can contain one or more formulae, equations, methods, etc. to interpret the data. The distance between marks in a pattern as well as the size, shape, color, orientation, etc. of the marks can be analyzed to decode the information encoded in the mark pattern of the fiduciary marker. The detection module may also include a database which contains the decryption information necessary to decode the particular fiduciary marker.

The original document may include one or more overt security marks as desired. In some embodiments, the overt security mark is a color shifting ink, a hologram, or a thermochromic material. A thermochromic material is a material possessing the ability to change color due to a temperature change.

The document of the present disclosure may also include additional covert and/or forensic security features. Such features may increase the difficulty and costs for counterfeiters and thus have a deterrent effect.

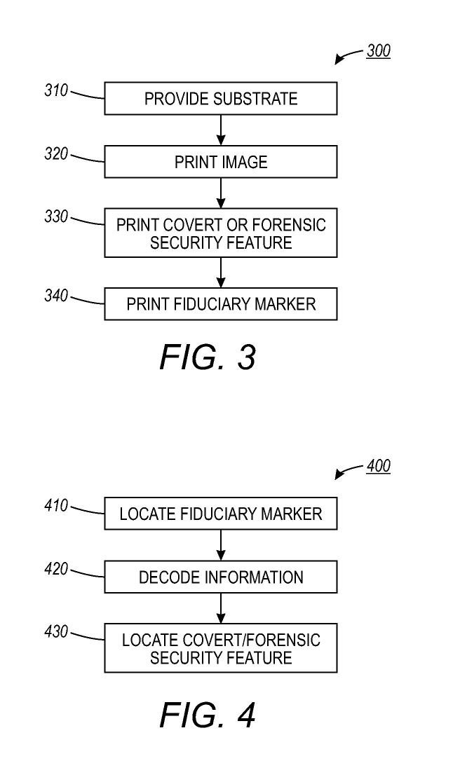

FIG. 3 is a flow chart for a process 300 of preparing a document having enhanced security. A substrate 310 is provided. An image, a hidden security feature, and a fiduciary marker are then printed on the document, and shown here as reference numerals 320, 330, 340. The “image” referred to in step 320 is the text and/or illustrations that provide the visible content of the document. The result is a document having enhanced security.

It should be noted that the printing of the image, hidden security feature, and fiduciary marker referred to here should not be construed as requiring one of these three elements to be printed in its entirety prior to printing another element. Practically speaking, in most inkjet printers, the document will be printed from the top of the substrate to the bottom of the substrate. The marks that make up these three elements will be printed based on their location on the substrate, not based on their designation as being part of the image, hidden security feature, and fiduciary marker.

FIG. 4 is a flow chart showing a verification process 400 in which a forensic examiner verifies that a given document is authentic or original, and is not a copy or a counterfeit. The examiner first locates a fiduciary marker 410 on the document. If the fiduciary marker is visible to the human eye, equipment is not necessary to locate the marker. However, if the fiduciary marker is transparent or is hidden, equipment may be necessary. Next, the examiner decodes information 420 encoded in the fiduciary marker. This information includes the location of at least one hidden security feature present in the document. The encoded information may also include the type of hidden security feature, and the equipment or methods needed to detect the hidden security feature. Information regarding settings that should be used on the equipment may also be encoded in the fiduciary marker. Once the examiner has decoded the information, s/he may then locate the at least one hidden security feature 430 using that information. The absence of the hidden security feature at the location indicated by the fiduciary marker is an indication that the document is counterfeit or a copy.

The highly specialized technology used to detect hidden security features, particularly forensic security features, is both expensive and time-consuming. By using the products and processes of the present disclosure, a forensic examiner can limit his or her search to specific locations on a given document, and more rapidly verify the authenticity of a document. Thus, cost and time savings can be achieved.

While particular embodiments have been described, alternatives, modifications, variations, improvements, and substantial equivalents that are or may be presently unforeseen may arise to applicants or other skilled in the art. Accordingly, the appended claims as filed and as they are amended are intended to embrace all such alternatives, modifications, variations, improvements, and substantial equivalents.

What is claimed is:

1. A method for reducing the difficulty of locating a hidden security feature on a substrate by a trusted party, comprising:
printing the hidden security feature on the substrate; and
printing a fiduciary marker on the substrate, the fiduciary marker encoding information about the location of the hidden security feature.

2. The method of claim 1, wherein the fiduciary marker is printed with a transparent ink.

3. The method of claim 1, wherein the fiduciary marker is visible.

4. The method of claim 1, wherein the hidden security feature is a micro-taggant, nanotext, an invisible barcode, an invisible image, a digital watermark, a hidden lenticular image, or a hidden polarized image.

5. The method of claim 1, wherein the fiduciary marker is printed on a blank space of the substrate.

6. The method of claim 1, wherein the fiduciary marker is printed in yellow ink on a white background of the substrate.

7. The method of claim 1, wherein the encoded information also includes the type of hidden security feature.

8. The method of claim 1, wherein the encoded information also includes the equipment or methods needed to detect the hidden security feature.

9. A method of verifying the authenticity of a document, comprising:
locating a fiduciary marker on the document, the fiduciary marker encoding information, wherein the encoded information is supposed to disclose the location of a hidden security mark on the document; and
decoding the information encoded in the fiduciary marker to determine whether the encoded information actually provides location information.

10. The method of claim 9, further comprising examining the location retrieved from the fiduciary marker to determine whether the hidden security mark is present on the document.

11. An document with enhanced security, comprising:
a hidden security feature; and
a fiduciary marker encoded with information about the location of the hidden security feature.

12. The document of claim 11, wherein the fiduciary marker comprises a transparent ink.

13. The document of claim 11, wherein the fiduciary marker is visible.

14. The document of claim 11, wherein the fiduciary marker comprises a barcode or a glyph.

15. The document of claim 11, wherein the fiduciary marker comprises yellow ink printed on a white background.

16. The document of claim 11, wherein the hidden security feature is a micro-taggant, nanotext, an invisible barcode, an invisible image, a digital watermark, a hidden lenticular image, or a hidden polarized image.

17. The document of claim 11, further comprising an overt security feature.

18. The document of claim 17, wherein the overt security feature is a color shifting ink, a hologram, or a thermochromic material.
